(19) United States
(12) Patent Application Publication
(10) Pub. No.: US 2010/0040016 A1
(43) Pub. Date: Feb. 18, 2010

(54) Wireless Network Handoff Method and Mobile Device Using Same

(76) Inventors: Kar-Wing Edward Lor, Hong Kong (CN); Yun Kau Lee, Hong Kong (CN); Siu Kai Yeung, Hong Kong (CN); Hiu Fung Lau, Hong Kong (CN)

Correspondence Address: WELLS ST. JOHN P.S., 601 W. FIRST AVENUE, SUITE 1300, SPOKANE, WA, 99201, US

(21) Appl. No.: 12/192,740

(22) Filed: Aug. 15, 2008

(51) Int. Cl. H04W 36/00

(52) U.S. Cl. 370/331

(57) ABSTRACT

In a method for wireless network handoff a mobile device scans for candidate wireless networks and authenticates for a access session with discovered networks as soon as the networks are discovered regardless of the presence of a handoff condition.

### BACKGROUND OF THE INVENTION

1. Field of the Invention

The current invention relates to wireless networks and to mobile devices that connect to wireless networks. In particular, the invention relates to the handoff in a mobile device of data streams between two overlapping wireless networks.

2. Background Information

The first mobile communication and data services were provided over mobile telephone networks. These networks are commonly referred to as cellular networks because they comprise a plurality of overlapping radio communication cells forming a coverage area. As a user of a mobile device moves through the coverage area communications via the mobile device are seamlessly handed-off between the cells.

More recently mobile communications using wireless computer networks has become increasingly popular. Wireless computer network access points generally have a very short range, however with the increase in a number of portable wireless devices having Wi-Fi connectivity Wi-Fi networks have proliferated throughout most urban areas. Extensive Wi-Fi coverage is now available in most major urban areas via public service providers or private organizations. An increasingly properly use for such Wi-Fi networks is for wireless IP telephone services or media streaming to handheld devices. However, in order to take full advantage of such services a wireless device must be able to seamlessly handoff data exchange from one wireless Access Points (APs) at another wireless AP.

FIGS. 1 and 2 illustrate a typical example of a current wireless network handoff method for a Wi-Fi enabled mobile device. The example given is that of VoIP telephone call on a Wi-Fi enable IP phone. The mobile IP phone is engaged in a VoIP telephone call with a second telephone device (not shown) via a first wireless network 1. The VoIP call media is routed via wireless network 1. As the mobile IP phone moves from location 3 to location 4 near the edge of the coverage area of wireless network 1 the signal strength of wireless network 1 falls. A handoff procedure is triggered when the signal level of wireless network 1 falls below a pre-determined threshold. The IP phone scans for a new wireless network and locates second wireless network 2. The handoff procedure involves association with second wireless network 2 and disassociation with first wireless network 1. At this point media exchange via first wireless network 1 stops. On association with second wireless network 2 the IP phone must acquiring an IP address via DHCP, and before network/internet access is granted must login to a session with the wireless service provider by providing a username and password to an Authentication server. The IP phone must then disassociate with second wireless network 2 and re-associate with first wireless network 1 so that it can send a sip “re-invite” message for transferring the VoIP call to second wireless network 2. The mobile telephone then re-associates with second wireless network 2 and media transfer resumes.

During this handoff procedure call media exchange is interrupted for a period of time N, which could be up to 30 seconds mainly due to the time taken for authentication with the is authentication server. Session authentication can take 20-30 seconds to complete, depending on the complication of the authentication message exchanges, load of authentication server, and Internet traffic. As the skilled addressee will appreciate, this would result in termination of the call either by the service provider or by the other party hanging-up.

### SUMMARY OF THE INVENTION

It is an object of the present invention to provide a method, and/or a portable wireless device using such a method, that ameliorates the interruption of media exchange during handoff between two wireless networks.

Accordingly there is provided a method for wireless network handoff in a portable wireless device wherein the device scans for candidate wireless networks and authenticates for a access session with discovered networks as soon as the networks are discovered regardless of the presence of a handoff condition.

According to a first particular aspect of the invention there is provided a wireless network handoff method for a portable wireless device, the method comprising authenticating for a service on two or more wireless networks such that the wireless device is simultaneously authenticated for services on the two or more wireless networks, sending and receiving data using one of the two or more wireless networks and handing-off the sending and receiving of data to another one of the wireless networks based on wireless network selection criteria.

According to a second particular aspect of the invention there is provided a portable wireless device comprising only one physical wireless network adapter, a virtual network adapter or device driver for emulating two or more wireless network connections using the physical wireless network adapter such that the device may simultaneously connect with two or more wireless networks, a network selector list comprising one or more of a list of preferred networks and/or a list of network selection criteria, and a network selector for comparing two or more connected wireless networks with the network selector list and selecting a preferred one of the connected networks.

Further aspects of the invention will become apparent from the following description which is given by way of example only.

### BRIEF DESCRIPTION OF THE DRAWINGS

The invention will now be described with reference to the accompanying drawings in which:

FIG. 1 is a schematic overview of wireless networks and a handoff method of the prior art,

FIG. 2 is a schematic illustration of messaging and media communications in the handoff method of the prior art,

FIG. 3 is a schematic overview of wireless networks and a pre-authentication method of the invention,

FIG. 4 is a flow diagram of a pre-authentication process of the current invention,

FIG. 5 is a flow diagram of handoff according to the current invention,

FIG. 6 is a schematic illustration of message and media communication according to the invention, and

FIG. 7 is a second schematic illustration of messaging and media communication according to the invention.

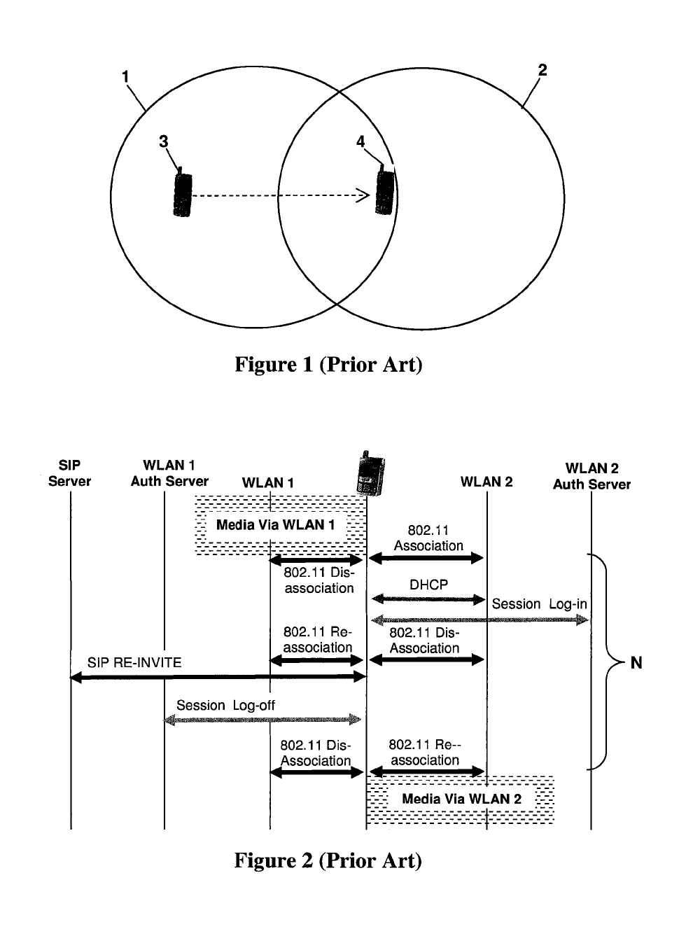

### DESCRIPTION OF THE EXEMPLARY EMBODIMENTS

The invention will now be described by way of example only with reference to a wireless IP telephone and to IEEE 802.11 wireless networks, commonly referred to as Wi-Fi networks. This is not however intended to limit the scope of use or functionality of the invention. Those skilled in the art will appreciate that the invention may be practiced with other portable wireless devices or computer systems that need to hand-off data exchange between wireless networks while maintaining a quasi real-time connection to another device or computer in another part of the network or via the internet. The invention may also be practiced in other wireless networking standards such as Bluetooth, Wireless 1394, Hiperlan, Hiperlan/2, HomeRF, OpenAir and others.

For the avoidance of doubt, in this specification the terms authentication and authenticate refer to session authentication with an Internet access service or a wireless network service, for example a Wi-Fi Hot Spot, by providing identification credentials such as a username and password to an authentication server in order to gain access to the Internet, interconnected networks or other network resources. Prior to such authentication a device must first connect to a wireless network in order to communicate with the authentication server. Connecting to a wireless network is also called association. In this specification it is assumed that all wireless networks are open access, however this is not essential to the invention and it may be, for example, that a network key is also required to ‘authenticate’ with the wireless network. In this specification, unless the use clearly requires it, the term authentication does not mean authentication with a wireless network using a network key.

A wireless mobile device is typically within the coverage range of two or more Wi-Fi networks at any one time. Each network is associated with an authentication server that allows a mobile device to authenticate for an Internet access service via the wireless network. As a mobile device moves from one place to another it may move outside of the range of some wireless network but into the range of other wireless network so that at all times it is within the range of several wireless network. In a method of handoff between access points according to the invention the mobile device will complete session authentication with every available wireless network for which it has session credentials regardless of the actual need for a handoff between wireless networks at the time when the session authentications take place. For example, if the mobile device is turned on and is within the coverage area of five wireless networks the device should complete session authentication via all five wireless networks immediately. The wireless networks may or may not belong to the same organization of service provider. Authenticating via all five wireless networks is however not essential to the invention and the device may authenticate via only two or more of the wireless networks, but it should authenticate via at least two wireless networks. Having authenticated via more than one wireless network, and so being simultaneously connected with more than one Internet session via more than one wireless network the device must then decide which network it will use for connecting to another device via the Internet. The device should only use only one network at a time for connecting to the Internet or for data exchange. The device chooses the one network that it will use for its connection or data exchange by assessing the network and or sessions against selection criteria. A plurality of different selection criteria may be used. For example, the selection criteria may be an ordered list of preferred networks or Internet access services, with the device selecting the most preferred network or Internet access service. Alternatively, or if there is no preferred network or Internet access service, the criteria could be condition criteria such as choosing the wireless network with the greatest signal strength, the greatest available network bandwidth, a desire level of security (either high security or low security depending on the application) the number of other connections to the wireless network or the amount of traffic on the wireless network, or usage costs. Once the mobile device has evaluated all of the available network against the selection criteria, it can select a network for use in communication or data exchange/streaming.

One advantage of the present invention is that because the mobile device is simultaneously authenticated with Internet access via two or more wireless networks it is able to handoff to a new wireless network immediately that a handoff criteria is met without needing to go through session authentication which can take up to 30 seconds. The mobile device periodically scans for new accessible wireless networks and authenticates regardless of whether a handoff criteria is present. When a handoff criteria is detected the device can immediately handover to the new wireless network. The mobile device may, for example, move into the coverage area of another wireless network which has a category higher on the preference list then the current network. After session authentication the device will assess all of the connected networks and on determining that the new network is now the preferred network will initiate a handover. Another example of the handoff decision the device, when periodically reassessing all of the wireless networks, determines that condition criteria of some of the networks has changed, for example signal strength, bandwidth, network traffic or number of connected devices. The device can make a decision to handoff to one of the other connected networks. The criteria for handoff is not critical to the invention and any known criteria for handoff may be used. An important aspect of the invention is that the mobile device pre-authenticates for internet access sessions via multiple available wireless networks regardless of whether a handoff condition is present or handoff is needed. By pre-authenticating before the handoff decision is made, or before handoff is necessary, the device can handoff quickly without the lengthy session authentication overhead. This potentially allows more frequent handoff based on more subtle handoff criteria.

An advantage of the handoff method of the current invention is that is it is client-based and so can be implemented in mobile devices without wireless network or server support. Most wireless hotspot service providers provide free service or charge a flat-rate or by traffic volume and so session pre-authentication will costs nothing or very little for the mobile device user.

As will be evident to the skilled addressee, pre-authenticating for multiple Internet service sessions via multiple wireless networks poses a number of technical problems. Most mobile wireless devices only have a single wireless network adapted and so can only connect with one wireless network at a time. The mobile device needs to make multiple wireless network connections simultaneously so that it can engage in an active Internet session while pre-authenticating on other networks. The inclusion of multiple wireless network adapters in a single device is impractical as it substantially increases the size, cost and power consumption of the device. Furthermore, having two or three wireless network adapters places a limit on the number of wireless networks with which the device can connect. The device of the invention therefore only has one physical wireless network adapter and uses a plurality of virtual network adapters or device drivers to emulate two or more wireless network connections using the one physical wireless network adapter of the device. Such an arrangement is already known in the art. Details can be found in US patent application publications 2004/0218580 and 2005/0063328, the entire contents of which are incorporated herein by reference. These publications describe how to achieve multiple wireless network connections with a single physical wireless network adapter by inserting virtual wireless LAN drivers into the network stack between the application and transport layers and the data and physical layers. The application and transport layers see multiple active network interfaces while the data and physical layers only see one active network adapter.

The second problem lies in communicating with the two or more wireless networks for pre-authentication with the service session while the mobile device is engaged in media streaming via one of the wireless networks or is connected in an IP telephone call. This problem is solved in the invention by using the IEEE 802.11 standard Power-save Mode. Before switching to one wireless network the mobile device informs other wireless networks that it is going into power-save more. The network access point will the queue packets destine for the mobile device. Specific details of a using the IEEE 802.11 standard Power-save Mode for doing this can be found in US patent publication 2008/0069065 to Wu and Lo. The entire contents of US patent publication 2008/0069065 is incorporated herein by reference. The Assignee of the present invention has rights to the invention disclosed in US 2008/0069065 by virtue of assignment from the inventors. Although Wu and Lo teach a different method of roaming between multiple wireless networks some of the techniques taught by Wu and Lo can be used to implement the current invention, like increasing the jitter buffer size, SIP's RE-INVITE, and use Power save mode frames to trick the AP

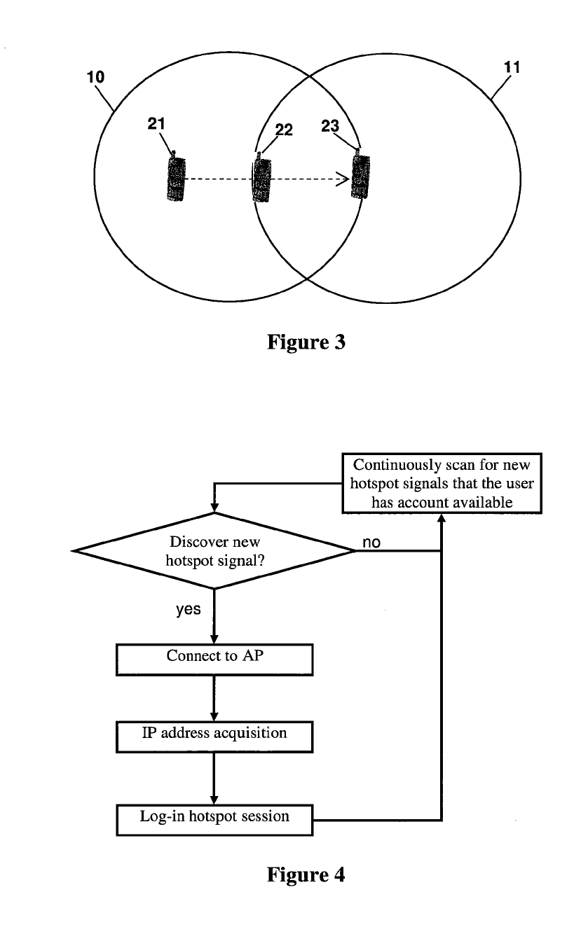

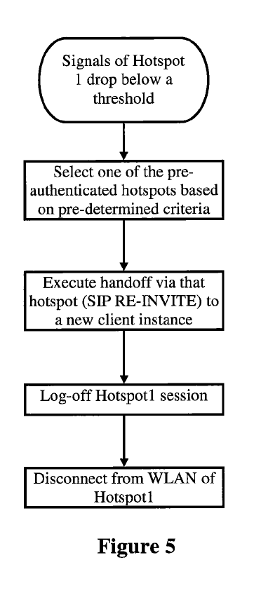

Turning now to the drawings, FIG. 3 schematically illustrates one scenario of handoff method of the invention. A mobile device at location 21 is connected with a first wireless network 10 and is involved in a VoIP call. The device periodically scans for new networks. When the device moves to location 22 the signal of wireless network 11 is detected. The device has an account available on network 11 and so immediately associates with network 11 and authenticates for an Internet session. The device continues with its session on network 10. When the device reaches location 23 the signal strength of wireless network 10 falls below a threshold triggering a handoff to wireless network 11. FIG. 4 shows the steps for pre-authentication via two or more wireless networks. The mobile device is continuously scanning for wireless networks that the user has an account available for. If the mobile device discovers a new network signal that is accessible because no account is necessary or because the user has an account available for that network then the mobile device associates with the network and acquires an IP address by DHCP. The device than pre-authenticates for internet access. Turning to FIG. 5, the procedure for a handoff is shown in the flow diagram. Although not intended to limit the scope or functionality of the invention, in FIG. 3 handoff is initiated by the wireless network signal of the currently preferred network falling below a threshold value. The device then selects one of the other pre-authenticated networks based on predetermined criteria such as the preference criteria or condition criteria. Once a new preferred network is determined a handoff procedure is initiated.

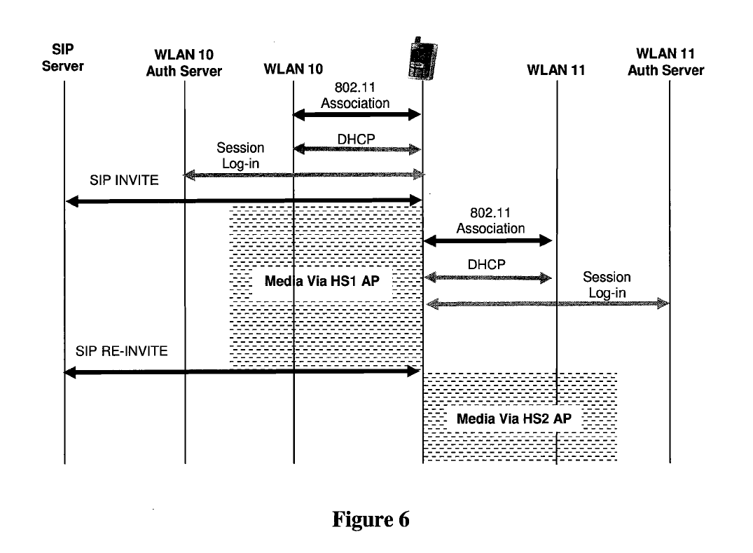

FIG. 6 shows message and media communication for the scenario depicted in FIG. 3. After power on the device associates with wireless network (WLAN) 10, obtains network parameters such as IP address via DHCP and authenticates with the network authentication server. The user make a VoIP call on the devices, which involves sending a SIP INVITE message to an Internet based SIP server. The VoIP call is connected with call media via the Internet connection on network 10. When the device reaches location 22 wireless network (WLAN) 11 is detected and the device associates with to wireless network (WLAN) 11, obtains network parameters such as IP address via DHCP and authenticates with the network 11 authentication server. The device is now simultaneously authenticated on two wireless networks. When location 23 is reached a handoff is initiated by sending a SIP RE-INVITE message to transfer the call media from network 10 to network 11. In the method of the invention there is no perceivable break the call media, just a simple rerouting of the media from wireless network 10 to wireless network 11.

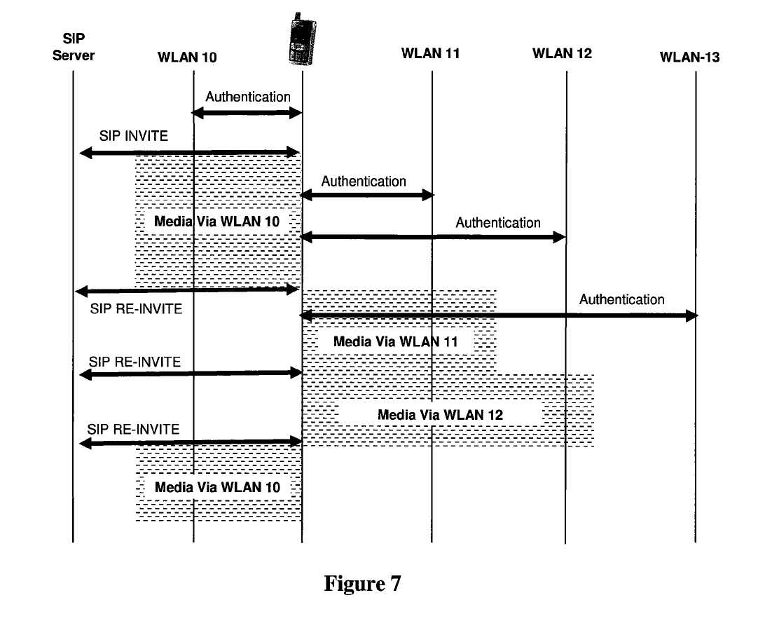

FIG. 7 shows message and media communication for a second scenario wherein the mobile device authenticates for internet access with more than two wireless networks. After power on the mobile device detects a first wireless network WLAN 10. The Mobile device associates with WLAN 10, obtains network parameters such as IP address via DHCP and authenticates with the network authentication server. In FIG. 7 the association and DHCP messages and authentication server are not shown for clarity. The user make a VoIP call on the device, which involves sending a SP INVITE message to an Internet based SIP server. The VoIP call is connected with call media via the Internet connection on WLAN 10. During the call the phone detects two further wireless networks WLAN 11 and WLAN 12 and associates and authenticates for internet access via these two networks. The device is now simultaneously authenticated on three wireless networks, namely WLAN 10, WLAN 11 and WLAN 12. A first handoff condition is detected and a SIP RE-INVITE causes handoff of call media to pre-authenticated WLAN 11. A further wireless network WLAN 13 is detected and associated and authenticated with. The device is now simultaneously authenticated on four wireless networks, namely WLAN 10, WLAN 11, WLAN 12 and WLAN 13. As the user of the mobile device continues to move a second handoff condition is detected and a second SIP RE-INVITE causes handoff of call media to pre-authenticated network WLAN 12. The user of the mobile device then move back towards where the call was first placed and a third handoff condition is detected and a third SIP RE-INVITE causes handoff of call media back to pre-authenticated network WLAN 10.

The above discussion does not touch on log-off and dissociation with a wireless network after handoff. If a device hands-off from a network it may stay authenticated on that network or if certain log-off criteria are met may log-off from its service session and dissociate from the wireless network. Such log-off criteria may be low signal strength. If the device moves outside of the coverage area of a wireless network without logging off, its session authentication will timeout. The method of log-off and dissociation are not critical to the invention.

What we claim is:

1. A wireless network handoff method for a portable wireless device, the method comprising:
authenticating for a service on two or more wireless networks such that the wireless device is simultaneously authenticated for services on the two or more wireless networks,
sending and receiving data using one of the two or more wireless networks, and
handing-off the sending and receiving of data to another one of the wireless networks based on wireless network selection criteria.

2. The wireless network roaming method of claim 1 wherein handing-off the sending and receiving of data comprises periodically comparing the two or more wireless networks with the network selection criteria and, if necessary, handing-off the sending and receiving of data from one of the wireless networks to another one of the wireless networks.

3. The wireless network roaming method of claim 2 wherein comparing the two or more wireless networks with the network selection criteria comprises comparing the two or more wireless networks with one or both of preference criteria and condition criteria.

4. The wireless network roaming method of claim 3 wherein comparing the two or more wireless networks with preference criteria comprises comparing the two or more wireless networks with an ordered list of preferred wireless networks.

5. The wireless network roaming method of claim 3 wherein comparing the two or more wireless networks with the condition criteria comprises determining a value for one or more of signal strength, bandwidth, security and traffic of the two or more wireless networks and comparing with threshold values.

6. The method of claim 1 further comprising, while sending and receiving data using only one of the two or more wireless networks, periodically communicating with the other ones of the two or more wireless networks so as to remain simultaneously connected with all of the two or more wireless networks.

7. The method of claim 1 wherein authenticating with two or more wireless networks comprises providing authentication credentials to an authentication server.

8. The method of claim 1 wherein connecting with two or more wireless networks S comprises discovering wireless networks and authenticating for a service on all accessible wireless networks discovered.

9. The method of claim 1 wherein connecting with two or more wireless networks comprises authenticating with two or more wireless networks using a single wireless network adaptor of the device.

10. The method of claim 1 wherein sending and receiving data comprises sending and receiving data using a system of interconnected computer networks.

11. The method of claim 1 wherein sending and receiving data comprises sending and receiving real-time oral conversation data.

12. A wireless computer network roaming method for a portable wireless device, the method comprising:
discovering accessible Wi-Fi networks,
authenticating with a service on all off the accessible Wi-Fi networks such that the wireless device is simultaneously authenticated for a service on the accessible Wi-Fi networks,
sending and receiving data using only a first one of the accessible Wi-Fi networks,
assessing the accessible Wi-Fi networks to identify a preferred Wi-Fi network,
if the preferred Wi-Fi network is not the first one of the accessible Wi-Fi networks then changing the sending and receiving of data to the preferred Wi-Fi network, wherein authenticating with a service comprises providing authentication credentials to an authentication server

13. A portable wireless device comprising:
only one physical wireless network adapter,
a virtual network adapter or device driver for emulating two or more wireless network connections using the physical wireless network adapter such that the device may simultaneously connect with two or more wireless networks,
a network selector list comprising one or more of a list of preferred networks and/or a list of network selection criteria, and
a network selector for comparing two or more connected wireless networks with the network selector list and selecting a preferred one of the connected networks.

14. The portable wireless device of claim 13 wherein the physical wireless network adapter is a Wi-Fi network adapter.

15. The portable wireless device of claim 13 further comprising a device processor and the device driver, and wherein the device driver is loaded to the device processor.

16. The portable wireless device of claim 13 comprising the virtual network adapter and wherein the virtual network adapter is in the physical wireless network adapter.

17. The portable wireless device of claim 13 wherein the list of preferred networks comprises an ordered list of preferred networks.

18. The portable wireless device of claim 13 wherein the list of network selection criteria comprises a of threshold values for one or more of network signal strength, bandwidth, security and traffic.

19. The portable wireless device of claim 13 which is a wireless IP phone.

20. A method of operating a wireless IP phone comprising:
simultaneously pre-authenticating for a service on a plurality of wireless IP networks,
sending and receiving conversation data using only one connected network at a time,
changing the network used for sending and receiving conversation based on network selection criteria.
